(19) United States
(12) Patent Application Publication
(10) Pub. No.: US 2026/0164388 A1
(43) Pub. Date: Jun. 11, 2026

(54) Providing Anti-Fraud Protection in a 5G Network Using Offline Registration

(71) Applicant: AT&T Intellectual Property I, L.P., Atlanta, GA (US)

(72) Inventors: Nashwa Sidhom, Edison, NJ (US); Joseph Soryal, Glendale, NY (US)

(73) Assignee: AT&T Intellectual Property I, L.P., Atlanta, GA (US)

(21) Appl. No.: 18/975,223

(22) Filed: Dec. 10, 2024

(51) Int. Cl. H04W 60/04; H04W 12/122; H04W 12/63; H04W 60/06

(52) U.S. Cl. CPC H04W 60/04; H04W 12/122; H04W 12/63; H04W 60/06

(57) ABSTRACT

Providing anti-fraud protection in a 5G network using offline registration can include receiving a deregistration message generated by a user device in communication with a gNodeB of a 5G network. Device data that identifies the user device and defines a state of the user device as being an offline registration state can be stored. A command can be generated to indicate that the user device is in the offline registration state and the command can be sent to a network controller on the 5G network, thereby preventing registration of devices that appear to be the user device until an updated command is received. Certain activities of any device appearing to the be user device can be limited until full registration of the user device is requested and verified.

### BACKGROUND

In modern networks, devices can be tracked by identity associated with the devices and/or users of the devices. In some instances, subscriber identity modules (“SIMs”) or other functionality can be used to authenticate devices or users when a device attaches to a network. Malicious actors, however, have created methods to attempt to illegally clone SIMs. Such illegally cloned SIMs may be used to attempt to gain access to protected resources such as cloud storage, banking platforms, or the like.

In some instances, malware installed on a device may inform a malicious actor that a particular device has been powered off or otherwise deregistered from a network, and the malicious actor may exploit that situation to attack. Namely, an attack using the cloned SIM may be initiated at a time when the authentic SIM appears to be offline. Thus, suspicions may not be raised by an operator of the network (for example, by seeing two ostensibly identical devices on the network). Thus, a network may allow a device to attach to the network using the cloned SIM and allow that device to access to various protected resources.

### SUMMARY

The present disclosure is directed to providing anti-fraud protection in a fifth generation (“5G”) mobility network (hereinafter referred to as a “5G network”) using offline registration. A user device can include an auxiliary processor, an auxiliary location device, an auxiliary power source, an auxiliary communication interface, and an auxiliary storage (e.g., a memory or the like). The auxiliary processor, the auxiliary location device, the auxiliary communication interface, and the auxiliary storage can be configured to be powered by the auxiliary power source and can be configured to operate when the user device is powered off. It should be understood that this example embodiment is illustrative, and therefore should not be construed as being limiting in any way.

At some point in time, the user device can register, for example with the network and/or a 5G network. The user device can be provisioned with services and/or operate on the network and/or the 5G network as is generally understood. The user device or a registration management service can determine that the user device is about to deregister from the network and/or the 5G network due to the user device being switched to airplane mode, being powered off, moving to a location at which no cellular signal is available, combinations thereof, or the like. Based on detecting the deregistration event, the user device can determine that the user device is to activate an offline registration state. In some embodiments, the user device can be instructed, for example by the registration management service or other entity (such as an access and mobility management function (“AMF”) on the 5G network) to activate the offline registration state.

The user device can activate the offline registration state to periodically send offline registration messages to the gNodeB or other element on the network and/or 5G network. The registration messages can include location data (that indicates a geographic location of the user device) and operational state data for the user device. The offline registration messages can be received at the registration management service, and the registration management service (which can be provided in some embodiments by the AMF of the 5G network) can update device data (which can be provided by a unified data registry (“UDR”) and/or a unified data management (“UDM”) entity of the 5G network) for the user device to indicate that the user device is in the offline registration state. The registration management service also can generate and send commands to a network controller and/or other entities to prevent other devices from registering with the network and/or 5G network as the user device until the user device is no longer in the offline registration state, thereby attempting to prevent fraud from devices attempting to clone the user device while in the offline registration state.

The user device can send the offline registration messages at intervals that can be determined by the user device based on a power level of the auxiliary power source. As the power level of the auxiliary power source is reduced, the frequency with which the user device sends the offline registration messages can also be reduced. When the user device requests full registration again (e.g., when the airplane mode is deactivated, when the user device is powered on, or the like), the registration management service can validate the request and generate updated commands and updated device data if appropriate. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include receiving a deregistration message generated by a user device in communication with a gNodeB of a 5G network. The deregistration message can be received with location data that indicates a geographic location of the user device when a deregistration event occurs and connection parameters that can define a connection between the user device and the gNodeB. The operations can further include storing device data that identifies the user device and defines a state of the user device as being an offline registration state; generating a command that indicates that the user device is in the offline registration state; and sending, to a network controller operating on the 5G network, the command. The network controller can prevent registration of devices that appear to be the user device until an updated command is received. The operations further can include receiving, from the user device, an offline registration message that is sent by the user device using an auxiliary communication interface of the user device. The offline registration message can include further location data that can be captured by an auxiliary location device of the user device and operating state data for the user device. The operations further can include in response to detecting a request for full registration of the user device, updating the device data to indicate that the state of the user device is registered, and sending the updated command to the network controller to stop preventing registration of the devices that appear to be the user device.

In some embodiments, the request for the full registration of the user device can include a validation message that can be generated by the user device and that can be sent via the auxiliary communication interface. In some embodiments, the command can cause the network controller to prevent delivery of text messages to the devices that appear to be the user device until the updated command is received. In some embodiments, the deregistration event can include powering off of the user device. In some embodiments, a further offline registration message can be received after a first time interval passes after receiving the offline registration message, where the first time interval can be set by the user device based on a power level of an auxiliary power source of the user device after sending the offline registration message. Another offline registration message can be received after a second time interval passes after receiving the further offline registration message, and the second time interval can be set by the user device based on a further power level of the auxiliary power source of the user device after sending the further offline registration message.

In some embodiments, operations can further include instructing the user device to activate an offline registration application in response to determining that the user device is about to lose the connection between the user device and the gNodeB; and comparing, after the full registration is requested, updated location data that indicates an updated geographic location of the user device and updated connection parameters to determine if the user device is requesting the full registration or if a malicious device is attempting to register as the user device. In some embodiments, the deregistration message can be received at an access and mobility management function of the 5G network, and the network controller can include a unified data registry and a unified data management entity of the 5G network.

According to another aspect of the concepts and technologies disclosed herein, a method is disclosed. The method can include receiving, at a computer that includes a processor, a deregistration message generated by a user device in communication with a gNodeB of a 5G network. The deregistration message can be received with location data that indicates a geographic location of the user device when a deregistration event occurs and connection parameters that can define a connection between the user device and the gNodeB. The method can further include storing, by the processor, device data that identifies the user device and defines a state of the user device as being an offline registration state; generating, by the processor, a command that indicates that the user device is in the offline registration state; and sending, by the processor and to a network controller operating on the 5G network, the command. The network controller can prevent registration of devices that appear to be the user device until an updated command is received. The method further can include receiving, by the processor and from the user device, an offline registration message that is sent by the user device using an auxiliary communication interface of the user device. The offline registration message can include further location data that can be captured by an auxiliary location device of the user device and operating state data for the user device. The method further can include in response to detecting a request for full registration of the user device, updating, by the processor, the device data to indicate that the state of the user device is registered, and sending, by the processor, the updated command to the network controller to stop preventing registration of the devices that appear to be the user device.

In some embodiments, the request for the full registration of the user device can include a validation message that can be generated by the user device and that can be sent via the auxiliary communication interface. In some embodiments, the command can cause the network controller to prevent delivery of text messages to the devices that appear to be the user device until the updated command is received. In some embodiments, the deregistration event can include powering off of the user device. In some embodiments, a further offline registration message can be received after a first time interval passes after receiving the offline registration message, where the first time interval can be set by the user device based on a power level of an auxiliary power source of the user device after sending the offline registration message. Another offline registration message can be received after a second time interval passes after receiving the further offline registration message, and the second time interval can be set by the user device based on a further power level of the auxiliary power source of the user device after sending the further offline registration message.

In some embodiments, operations can further include instructing the user device to activate an offline registration application in response to determining that the user device is about to lose the connection between the user device and the gNodeB; and comparing, after the full registration is requested, updated location data that indicates an updated geographic location of the user device and updated connection parameters to determine if the user device is requesting the full registration or if a malicious device is attempting to register as the user device. In some embodiments, the deregistration message can be received at an access and mobility management function of the 5G network, and the network controller can include a unified data registry and a unified data management entity of the 5G network.

According to yet another aspect of the concepts and technologies disclosed herein, a computer storage medium is disclosed. The computer storage medium can store computer-executable instructions that, when executed by a processor, cause the processor to perform operations. The operations can include receiving a deregistration message generated by a user device in communication with a gNodeB of a 5G network. The deregistration message can be received with location data that indicates a geographic location of the user device when a deregistration event occurs and connection parameters that can define a connection between the user device and the gNodeB. The operations can further include storing device data that identifies the user device and defines a state of the user device as being an offline registration state; generating a command that indicates that the user device is in the offline registration state; and sending, to a network controller operating on the 5G network, the command. The network controller can prevent registration of devices that appear to be the user device until an updated command is received. The operations further can include receiving, from the user device, an offline registration message that is sent by the user device using an auxiliary communication interface of the user device. The offline registration message can include further location data that can be captured by an auxiliary location device of the user device and operating state data for the user device. The operations further can include in response to detecting a request for full registration of the user device, updating the device data to indicate that the state of the user device is registered, and sending the updated command to the network controller to stop preventing registration of the devices that appear to be the user device.

In some embodiments, the request for the full registration of the user device can include a validation message that can be generated by the user device and that can be sent via the auxiliary communication interface. In some embodiments, the command can cause the network controller to prevent delivery of text messages to the devices that appear to be the user device until the updated command is received. In some embodiments, the deregistration event can include powering off of the user device. In some embodiments, a further offline registration message can be received after a first time interval passes after receiving the offline registration message, where the first time interval can be set by the user device based on a power level of an auxiliary power source of the user device after sending the offline registration message. Another offline registration message can be received after a second time interval passes after receiving the further offline registration message, and the second time interval can be set by the user device based on a further power level of the auxiliary power source of the user device after sending the further offline registration message.

In some embodiments, operations can further include instructing the user device to activate an offline registration application in response to determining that the user device is about to lose the connection between the user device and the gNodeB; and comparing, after the full registration is requested, updated location data that indicates an updated geographic location of the user device and updated connection parameters to determine if the user device is requesting the full registration or if a malicious device is attempting to register as the user device. In some embodiments, the deregistration message can be received at an access and mobility management function of the 5G network, and the network controller can include a unified data registry and a unified data management entity of the 5G network.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for providing anti-fraud protection in a 5G network using offline registration, according to an illustrative embodiment of the concepts and technologies described herein.

FIG. 3 is a flow diagram showing aspects of a method for providing anti-fraud protection in a 5G network using offline registration, according to another illustrative embodiment of the concepts and technologies described herein.

FIG. 4 is a flow diagram showing aspects of a method for providing anti-fraud protection in a 5G network using offline registration, according to yet another illustrative embodiment of the concepts and technologies described herein.

FIG. 5 schematically illustrates a network, according to an illustrative embodiment of the concepts and technologies described herein.

FIG. 6 is a block diagram illustrating an example computer system configured to providing anti-fraud protection in a 5G network using offline registration, according to some illustrative embodiments of the concepts and technologies described herein.

FIG. 7 is a block diagram illustrating an example mobile device configured to interact with a registration management service, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to providing anti-fraud protection in a 5G network using offline registration. A user device can include an auxiliary processor, an auxiliary location device, an auxiliary power source, an auxiliary communication interface, and an auxiliary storage. The auxiliary processor, the auxiliary location device, the auxiliary communication interface, and the auxiliary storage can be configured to be powered by the auxiliary power source and can be configured to operate when the user device is powered off. It should be understood that this example embodiment is illustrative, and therefore should not be construed as being limiting in any way.

At some point in time, the user device can register, for example with the network and/or a 5G network. The user device can be provisioned with services and/or operate on the network and/or the 5G network as is generally understood. The user device or a registration management service can determine that the user device is about to deregister from the network and/or the 5G network due to the user device being switched to airplane mode, being powered off, moving to a location at which no cellular signal is available, combinations thereof, or the like. Based on detecting the deregistration event, the user device can determine that the user device is to activate an offline registration state. In some embodiments, the user device can be instructed, for example by the registration management service or other entity (such as an AMF on the 5G network) to activate the offline registration state.

The user device can activate the offline registration state to periodically send offline registration messages to the gNodeB or other element on the network and/or 5G network. The registration messages can include location data (that indicates a geographic location of the user device) and operational state data for the user device. The offline registration messages can be received at the registration management service, and the registration management service (which can be provided in some embodiments by the AMF of the 5G network) can update device data (which can be provided by a UDR and/or UDM of the 5G network) for the user device to indicate that the user device is in the offline registration state. The registration management service also can generate and send commands to a network controller and/or other entities to prevent other devices from registering with the network and/or 5G network as the user device until the user device is no longer in the offline registration state, thereby attempting to prevent fraud from devices attempting to clone the user device while in the offline registration state.

The user device can send the offline registration messages at intervals that can be determined by the user device based on a power level of the auxiliary power source. As the power level of the auxiliary power source is reduced, the frequency with which the user device sends the offline registration messages can also be reduced. When the user device requests full registration again (e.g., when the airplane mode is deactivated, when the user device is powered on, or the like), the registration management service can validate the request and generate updated commands and updated device data if appropriate. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

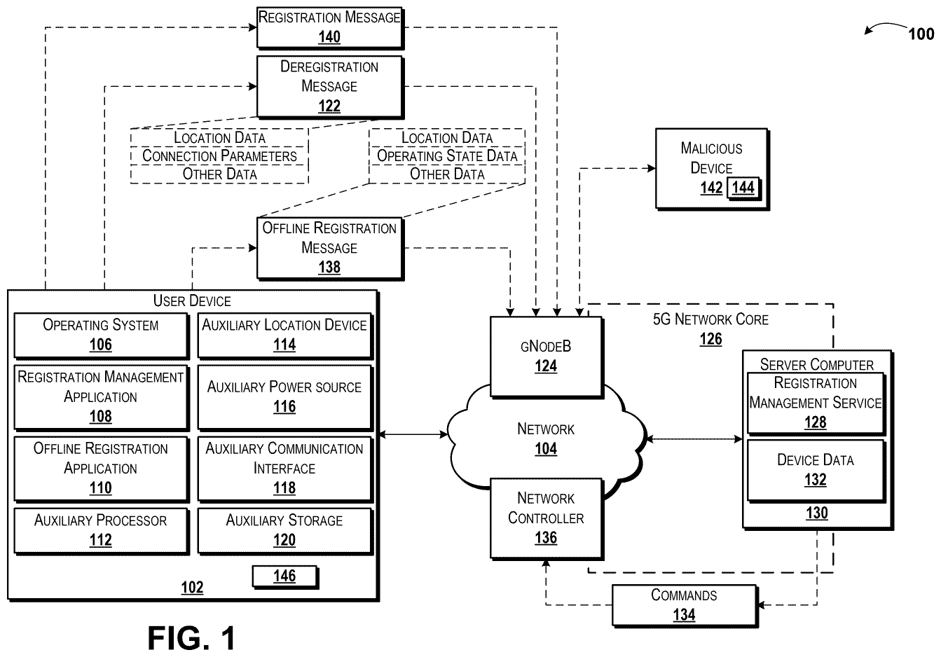

Referring now to FIG. 1, aspects of an operating environment 100 for various embodiments of the concepts and technologies disclosed herein for providing anti-fraud protection in a 5G network using offline registration will be described, according to an illustrative embodiment. The operating environment 100 shown in FIG. 1 includes a user device 102. The user device 102 can operate in communication with and/or as part of a communications network (“network”) 104, though this is not necessarily the case in all embodiments.

According to various embodiments, the functionality of the user device 102 may be provided by one or more desktop computers, mobile telephones, laptop computers, smartwatches, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can execute an operating system 106 and one or more application programs such as, for example, a registration management application 108 and an offline registration application 110. The operating system 106 can include a computer program that can control the operation of the user device 102. The registration management application 108 and the offline registration application 110 can include executable programs that can be configured to execute on top of the operating system 106 to provide various functions as illustrated and described herein. Although illustrated herein as separate application programs, it should be understood that the functionality of the registration management application 108 and/or the offline registration application 110 can be incorporated into a single application and/or can be incorporated into and/or provided by the operating system 106. As such, it should be understood that this example embodiment is illustrative, and therefore should not be construed as being limiting in any way. The functionality of the registration management application 108 and the offline registration application 110 will be described in more detail herein after introducing additional components and entities illustrated in the operating environment 100 shown in FIG. 1.

As shown in FIG. 1, the user device 102 also can include an auxiliary processor 112 (in addition to at least one main processor, which is not labeled in FIG. 1), an auxiliary location device 114 (in addition to at least one other location device, which is not labeled in FIG. 1), an auxiliary power source 116 (in addition to at least one other power source, which is not labeled in FIG. 1), an auxiliary communication interface 118 (in addition to at least one other communication interface, which is not labeled in FIG. 1), and an auxiliary storage 120 (in addition to at least one other storage device, which is not labeled in FIG. 1). These components and the function thereof will be described in more detail herein after introducing other components and entities illustrated in the operating environment 100 shown in FIG. 1.

According to various embodiments of the concepts and technologies disclosed herein, the user device 102 can be configured to send a deregistration message 122 to a device or entity on the network 104 and/or a cellular network associated therewith and/or connected thereto such as a gNodeB 124 or other device, which can then provide the deregistration message 122 and/or information therefrom to other devices via a 5G network core 126, transport layer of the 5G network, other network connections, combinations thereof, or the like. It should be understood that this example embodiment is illustrative, and therefore should not be construed as being limiting in any way.

In various embodiments, the deregistration message 122 can be generated by the user device 102 (e.g., via executing the registration management application 108 and/or the offline registration application 110 as will be illustrated and described herein). The deregistration message 122 can include, for example, location data that identifies a geographic location of the user device 102 when deregistering, one or more connection parameters (e.g., an antenna, radio unit, or the like to which the user device 102 is connected; a signal strength, bandwidth, and/or quality of service (“QoS”) for the user device 102; combinations thereof; or the like), and other information such as battery level and/or other operating characteristics of the user device 102. These and/or other information can be captured by the user device 102 and included in the deregistration message 122. It should be understood that this example embodiment is illustrative, and therefore should not be construed as being limiting in any way.

According to various embodiments of the concepts and technologies disclosed herein, the gNodeB 124 can be configured to communicate the deregistration message 122 and/or the contents thereof to a registration management service 128, which can operate on the 5G network core 126 as a service or application (e.g., on a server computer 130). In some embodiments, the registration management service 128 can be operated as a service on a server computer 130 that operates on other networks, as a cloud service, or the like. As such, it should be understood that this example embodiment is illustrative, and therefore should not be construed as being limiting in any way.

The registration management service 128 can be configured to create, store, and/or use device data 132 for one or more devices such as the user device 102. The device data 132 for the user device 102, for example, can include device or user identifiers (e.g., device identifiers such as an international mobile subscriber identity (“IMSI”), an international mobile equipment identity (“IMEI”), a globally unique identifier (“GUID”), a device serial number, a media access control (“MAC”) address for the user device 102, operating state of the user device 102 (e.g., registered, offline registration state, offline, or the like), location information for the user device 102 (e.g., a current or last known geographic location of the user device 102), combinations thereof, or the like. Thus, it can be appreciated that the device data 132 can correspond to a subscriber database such as, for example, UDR and/or UDM of the 5G network. Thus, it can be appreciated that the device data 132 can be kept current by the registration management service 128 and/or other entities on the network 104 and/or 5G network and/or 5G network core 126. It should be understood that this example embodiment is illustrative, and therefore should not be construed as being limiting in any way.

The registration management service 128 also can be configured to create one or more commands 134 for instructing network entities (e.g., on the network 104, on the 5G network core 126, and/or elsewhere) to manage access of the user device 102 to the network 104. In some embodiments, the commands 134 can be provided to a network controller 136 or other device. In various embodiments of the concepts and technologies disclosed herein, the functionality of the network controller 136 illustrated and described herein can be provided by an AMF of the 5G network core 126 and/or other device that can manage connections and/or services for the user device 102 and/or other devices. Because additional and/or alternative entities can provide the functionality of the network controller 136 illustrated and described herein, it should be understood that this example embodiment is illustrative, and therefore should not be construed as being limiting in any way.

The user device 102 also can be configured to generate and send one or more offline registration messages 138. The offline registration messages 138 can be sent when the user device 102 is not connected to the 5G network (e.g., via the gNodeB 124) using the primary communication interface as will be illustrated and described herein. The offline registration message 138 can include data captured by the user device 102. In some embodiments, for example, the offline registration message 138 can include location data captured by the auxiliary location device 114, operating state data that reflects activity and/or operational state information for the user device 102, and other information as illustrated and described herein. The offline registration message 138 can also be sent by the user device 102 (e.g., using the auxiliary communication interface 118) to the gNodeB 124 as will be explained.

At some point in time, the user device 102 can request registration with the network 104, e.g., via sending a registration message 140 to the gNodeB 124. It should be understood that this example embodiment is illustrative, and therefore should not be construed as being limiting in any way. Additionally, the operating environment 100 illustrates a malicious device 142. The malicious device 142 can correspond to a device that attempts to connect to the 5G network core 126 (e.g., via the gNodeB 124) and/or other resources on or in communication with the network 104 and/or 5G network. The malicious device 142 in various embodiments of the concepts and technologies disclosed herein can attempt to spoof or impersonate the user device 102 (e.g., using a cloned subscriber identity module (“SIM”) or the like). Embodiments of the concepts and technologies disclosed herein are provided to prevent such attacks and/or other malicious activity. Now that the entities in the operating environment 100 have been briefly discussed, the functionality of these entities will be described in more detail.

According to various embodiments of the concepts and technologies disclosed herein, the registration management application 108 can be configured to manage registration of the user device 102 with the network 104 and/or other networks illustrated and described herein (e.g., a 5G cellular network or the like). In particular, as is generally understood, the user device 102 can be configured to attach to a mobility network such as a 5G cellular network by sending a registration message 140 to a gNodeB 124. In some embodiments, the gNodeB 124 can relay information from the registration message 140 to other entities on the 5G network core 126 (e.g., an AMF or the like) for registration of the user device 102 and provisioning of services to the user device 102. Registration of the user device 102 can be managed by the AMF or other entities on the 5G network (or 5G network core 126), and eventually the user device 102 can be provisioned with services as is generally understood. It should be understood that in some embodiments of the concepts and technologies disclosed herein, the functionality of the registration management application 108 can be incorporated into the operating system 106 and/or other applications, services, modules, or the like. It should be understood that this example embodiment is illustrative, and therefore should not be construed as being limiting in any way.

The registration management application 108 also can be configured to detect, based on various connection parameters such as signal strength, bandwidth, quality of service indicators and/or other various key performance indicators (“KPIs”), combinations thereof, or the like; based on explicit action by the user device 102 (e.g., activation of airplane mode, or the like); that the user device 102 is about to deregister from the network 104, the 5G cellular network, or other connection. Prior to deregistering from the connection (or prior to losing some signal that the registration management application 108 determines is associated with the connection), the registration management application 108 can capture various data and provide these data to the 5G network as part of a deregistration message 122.

As noted above, the deregistration message 122 can indicate that the user device 102 is about to deregister from the connection (e.g., with the gNodeB 124 or other device) and can provide the 5G network (e.g., via communicating with the gNodeB 124 or the like) with connection information such as location data that indicates the geographic location of the user device 102 at the time of deregistration, connection parameters associated with the connection at the time of deregistration, and/or other data (e.g., operating state of the user device 102 at the time of deregistration, a user associated with the user device 102 at the time of deregistration, other devices or entities in proximity to the user device 102 at the time of deregistration, combinations thereof, or the like). The user device 102 can send the deregistration message 122 to the gNodeB 124, which can be configured to provide the deregistration message 122 (and/or contents thereof) to the registration management service 128. In some embodiments of the concepts and technologies disclosed herein, the functionality of the registration management service 128 can be provided by an AMF of the 5G network, the network controller 136 illustrated and described herein, and/or other entities. It should be understood that this example embodiment is illustrative, and therefore should not be construed as being limiting in any way.

According to various embodiments of the concepts and technologies disclosed herein, a deregistration event associated with the user device 102 can include, for example, activation of an airplane mode at the user device 102, powering off of the user device 102, loss of signal by the user device 102 and/or the 5G network, combinations thereof, or the like. Thus, it should be understood that deregistration events can include the user device 102 being powered off. As will be illustrated and described herein, the user device 102 can be configured to continue communicating with the 5G network after being powered off. It should be understood that this example embodiment is illustrative, and therefore should not be construed as being limiting in any way.

The registration management application 108 also can be configured, in some embodiments, to invoke the offline registration application 110 (and/or functionality associated therewith) when deregistration is detected (or expected to occur). In some embodiments, the network controller 136 and/or registration management service 128 can be configured to trigger activation of the offline registration application 110 (e.g., via delivering a command to the user device 102 via the gNodeB 124 and/or other entities). It should be understood that this example embodiment is illustrative, and therefore should not be construed as being limiting in any way.

The offline registration application 110 can be configured to manage offline registration with the 5G network, e.g., via lightweight and/or ultra-light messaging with the 5G network (e.g., the gNodeB 124). In various embodiments of the concepts and technologies disclosed herein, the offline registration application 110 can be provided by an auxiliary processor 112 executing computer-executable instructions stored in an auxiliary storage 120 (e.g., a memory device or the like) to perform various operations as illustrated and described herein. In particular, the offline registration application 110 can be configured to detect a deregistration event that is about to occur or has occurred. In some embodiments, for example, the offline registration application 110 can detect the deregistration event by being invoked by the registration management application 108; by detecting powering off of the user device 102; by being activated by a remote service such as the registration management service 128, the network controller 136, or other entities in the 5G network or 5G network core 126; by detecting the user device 102 being switched to airplane mode; and/or other events. It should be understood that this example embodiment is illustrative, and therefore should not be construed as being limiting in any way.

Upon detecting the deregistration event, the offline registration application 110 can capture operating state data (e.g., state of the user device 102, state of a connection between the user device 102 and the gNodeB 124 that is provided by a primary communication interface such as a cellular transceiver, or other state information) and location data that defines a geographic location of the user device 102 at the time of deregistration. The geographic location of the user device 102 can be captured, in various embodiments, by the auxiliary location device 114. In various embodiments of the concepts and technologies disclosed herein, the auxiliary location device 114 can be provided by a low power global positioning service (“GPS”) receiver, or the like. It should be understood that this example embodiment is illustrative, and therefore should not be construed as being limiting in any way.

The offline registration application 110 can be configured, in various embodiments, to run off power from the auxiliary power source 116 (e.g., an auxiliary battery or the like) and therefore can run after the user device 102 is powered off in various embodiments. In various embodiments of the concepts and technologies disclosed herein, the offline registration application 110 can be configured to generate and send an offline registration message 138 to the 5G network (e.g., the gNodeB 124) that indicates that the user device 102 has been deregistered and/or that updates information associated with the user device 102 after deregistration. It should be understood that this example embodiment is illustrative, and therefore should not be construed as being limiting in any way.

The offline registration application 110 also can be configured to check a power level of the auxiliary power source 116. Based on the power level of the auxiliary power source 116, the offline registration application 110 can determine an interval for sending offline registration messages 138 to the 5G network. In particular, a first interval may be set for sending the offline registration messages 138 when the level of the auxiliary power source 116 is at a maximum level and that interval may be lengthened by the offline registration application 110 when the level of the auxiliary power source 116 decreases. Thus, the offline registration application 110 can be configured to manage the power consumption from the auxiliary power source 116 to attempt to lengthen the amount of time that the offline registration messages 138 can be sent by the user device 102. The offline registration application 110 can set the interval for offline registration messages 138 based on the power level of the auxiliary power source 116. According to various embodiments, the interval can be set based on an amount of power consumed by sending the offline registration messages 138 and a power level of the auxiliary power source 116. These and other data that can be used to set the interval can be stored in some embodiments at the user device 102 (e.g., in the auxiliary storage 120 or elsewhere). Thus, the offline registration application 110 can retrieve these and/or other data, determine the power level of the auxiliary power source 116, and determine the interval. Because the interval can be determined in additional and/or alternative manners, it should be understood that this example embodiment is illustrative, and therefore should not be construed as being limiting in any way.

The offline registration application 110 can also be configured to determine if full registration of the user device 102 has been requested (e.g., if a registration message 140 has been generated by the user device 102). Thus, the offline registration application 110 can determine, for example, if the user device 102 has been powered on since the offline registration application 110 was activated; if airplane mode has been deactivated at the user device 102; or if for any other reason the user device 102 has requested registration (e.g., by sending the registration message 140 to the gNodeB 124). If not, the offline registration application 110 can wait until the set interval passes before triggering transmission of another offline registration message 138 (which as noted above can include capturing location and operating state of the user device 102 and sending the offline registration message 138), checking the power level of the auxiliary power source and adjusting the interval (if appropriate). The offline registration application 110 can repeat these operations until the user device 102 requests full registration of the user device 102 with the 5G network. It should be understood that this example embodiment is illustrative, and therefore should not be construed as being limiting in any way.

According to various embodiments of the concepts and technologies disclosed herein, the registration management service 128 can be configured to track and/or manage registration of the user device 102, offline registration and/or tracking of the user device 102, to prevent fraud when the user device 102 is in an offline registration state (e.g., when in a state after sending one or more offline registration messages 138 and before re-registering with the 5G network), and/or to take other actions. According to various embodiments of the concepts and technologies disclosed herein, as noted above, the functionality of the registration management service 128 can be provided, in some embodiments, by the AMF of the 5G network. It should be understood that this example embodiment is illustrative, and therefore should not be construed as being limiting in any way.

In some other embodiments, the registration management service 128 can be configured to communicate with the AMF or other devices on the 5G network to prevent fraud and/or for other reasons. For example, the registration management service 128 can determine that the user device 102 is in an offline registration state (e.g., by detecting receipt of an offline registration message 138). The registration management service 128 can update the device data 132 or a portion thereof to indicate this change in the operating state of the user device 102. The registration management service 128 can also be configured to send a command 134 to the network controller 136 or other entity to prevent fraud based on the user device 102 being in an offline registration state.

In some embodiments, fraud can be prevented by the network controller 136 or other entities by preventing registration of any other device (other than the user device 102), for example the malicious device 142, with credentials associated with the user device 102 (e.g., a SIM or the like) until the user device 102 reattaches to the network 104. In one contemplated embodiment of the concepts and technologies disclosed herein, the malicious device 142 can store a spoof SIM 144. The spoof SIM 144 can be a clone or copy of a SIM 146 that may be stored on the user device 102. It should be understood that the functionality of the spoof SIM 144 and/or the SIM 146 can be provided by other authentication mechanisms such as a universal integrated circuit card (“UICC”), an electronic SIM (“eSIM”), software, or other hardware or software as is generally understood. As such, it should be understood that this example embodiment is illustrative, and therefore should not be construed as being limiting in any way.

When the malicious device 142 attempts to attach to the 5G network, the 5G network (e.g., various entities in the 5G network core 126, at the network controller 136, the registration management service 128, or the like) can determine if the identity provided by the malicious device 142 is associated with a device currently in an offline registration state (e.g., the user device 102 in some embodiments). This check can be performed in some embodiments based on a premise that malicious actors such as the malicious device 142 may attempt to register as the user device 102 when the user device 102 is powered off. For example, a malware installed on the user device 102 may inform the malicious device 142 when the user device 102 is being powered off. It should be understood that this example embodiment is illustrative, and therefore should not be construed as being limiting in any way.

At any rate, if the identity provided by the malicious device 142 is associated with a device currently in an offline registration state, the registration management service 128 can take actions to prevent fraud by the malicious device 142 and/or can trigger other entities (e.g., via the commands 134) to prevent fraud by the malicious device 142. In one contemplated example, the malicious device 142 may attempt to logon to some protected resource associated with the user device 102 (e.g., a cloud storage, a banking platform, or the like) that may require multifactor authentication (“MFA”). Because the 5G network may otherwise be spoofed into considering the malicious device 142 to be the user device 102, embodiments of the concepts and technologies disclosed herein include the registration management service 128 accessing the device data 132 or otherwise determining that the user device 102 is in an offline registration state.

This determination can lead the registration management service 128 to send commands 134 to various entities on the network 104 and/or the 5G network to prevent multifactor authentication or the like. For example, if the malicious device 142 selects an option to deliver a code via text message (which could be delivered to the malicious device 142 in some embodiments), the commands 134 generated by the registration management service 128 can stop the network 104 or 5G network from delivering the text message (e.g., by instructing a message delivery service to stop delivery of the text message and instead deliver the code via email to the user device 102 or an account associated therewith). It should be understood that this example embodiment is illustrative, and therefore should not be construed as being limiting in any way.

According to various embodiments of the concepts and technologies disclosed herein, the registration management service 128 can monitor the user device 102 and/or be updated when the user device 102 re-registers with the network 104 and/or the 5G network. If the registration management service 128 determines that the user device 102 has not re-registered (e.g., by detecting a registration message 140 for the user device 102), the registration management service 128 can wait for a next offline registration message 138 and continue to generate commands 134 based on the offline registration messages 138. If the registration management service 128 determines that the user device 102 has re-registered with the network 104 and/or the 5G network, the registration management service 128 can be configured to send a command 134 to the network controller 136 or other entities on the network or 5G network to indicate that the user device 102 is no longer in an offline registration state. The registration management service 128 also can be configured to update the device data 132 to indicate that the user device 102 has registered again. As such, the registration management service 128 can update various data and/or entities to indicate that the user device 102 has returned to a normal operating state. It should be understood that this example embodiment is illustrative, and therefore should not be construed as being limiting in any way.

In some embodiments, the registration management service 128 also can be configured to determine, when the user device 102 registers with the network 104 or 5G network, if the location and/or connection parameters associated with the user device 102 are consistent with the location and/or connection parameters associated with the user device 102 as captured in the deregistration message 122 (e.g., when the deregistration event occurred). For example, if the registration management service 128 determined that the user device 102 was losing signal and was about to be deregistered due to a lost signal, the registration management service 128 can be configured to check the location and connection parameters (e.g., which antenna, tower, or the like the user device 102 is connected to, or the like) to ensure that the location and connection parameters are consistent with the user device 102 re-registering at or near a location at which the signal was ostensibly lost or the user device 102 was deliberately disconnected. If the location and/or connection parameters at which the deregistration event occurred is not consistent with the location and/or connection parameters at which the user device 102 has again registered with the network 104 or the 5G network, the registration management service 128 can continue to treat the user device 102 as being in an offline registration state and/or take other steps to prevent fraud. It should be understood that this example embodiment is illustrative, and therefore should not be construed as being limiting in any way.

In practice, a user device 102 can include an auxiliary processor 112, an auxiliary location device 114, an auxiliary power source 116, an auxiliary communication interface 118, and an auxiliary storage 120 (e.g., a memory or the like). The auxiliary processor 112, the auxiliary location device 114, the auxiliary communication interface 118, and the auxiliary storage 120 can be configured to be powered by the auxiliary power source 116 and can be configured to operate when the user device 102 is powered off. It should be understood that this example embodiment is illustrative, and therefore should not be construed as being limiting in any way.

At some point in time, the user device 102 can register, for example with the network 104 and/or a 5G network. The user device 102 can be provisioned with services and/or operate on the network 104 and/or the 5G network as is generally understood. The user device 102 or a registration management service 128 can determine that the user device 102 is about to deregister from the network 104 and/or the 5G network due to the user device 102 being switched to airplane mode, being powered off, moving to a location at which no cellular signal is available, combinations thereof, or the like. Based on detecting the deregistration event, the user device 102 can determine that the user device 102 is to activate an offline registration state. In some embodiments, the user device 102 can be instructed, for example by the registration management service 128 or other entity (such as an AMF on the 5G network) to activate the offline registration state.

The user device 102 can activate the offline registration state to periodically send offline registration messages 138 to the gNodeB 124 or other element on the network 104 and/or 5G network. The registration messages 138 can include location data (that indicates a geographic location of the user device 102) and operational state data for the user device 102. The offline registration messages 138 can be received at the registration management service 128, and the registration management service 128 (which can be provided in some embodiments by the AMF of the 5G network) can update device data 132 (which can be provided by a UDR and/or UDM of the 5G network) for the user device 102 to indicate that the user device 102 is in the offline registration state. The registration management service 128 also can generate and send commands 134 to a network controller 136 and/or other entities to prevent other devices from registering with the network 104 and/or 5G network as the user device 102 until the user device 102 is no longer in the offline registration state, thereby attempting to prevent fraud from devices attempting to clone the user device 102 while in the offline registration state.

The user device 102 can send the offline registration messages 138 at intervals that can be determined by the user device 102 based on a power level of the auxiliary power source 116. As the power level of the auxiliary power source 116 is reduced, the frequency with which the user device 102 sends the offline registration messages 138 can also be reduced. When the user device 102 requests full registration again (e.g., when the airplane mode is deactivated, when the user device 102 is powered on, or the like), the registration management service 128 can validate the request and generate updated commands 134 and updated device data 132 if appropriate. It should be understood that this example embodiment is illustrative, and therefore should not be construed as being limiting in any way.

FIG. 1 illustrates one user device 102, one network 104, one gNodeB 124, one 5G network core 126, one server computer 130, one network controller 136, and one malicious device 142. It should be understood, however, that various implementations of the operating environment 100 can include zero, one, or more than one user device 102; zero, one, or more than one network 104; one or more than one gNodeB 124; one or more than one 5G network core 126; zero, one, or more than one server computer 130; zero, one, or more than one network controller 136; and zero, one, or more than one malicious device 142. As such, the illustrated embodiment should be understood as being illustrative, and should not be construed as being limiting in any way.

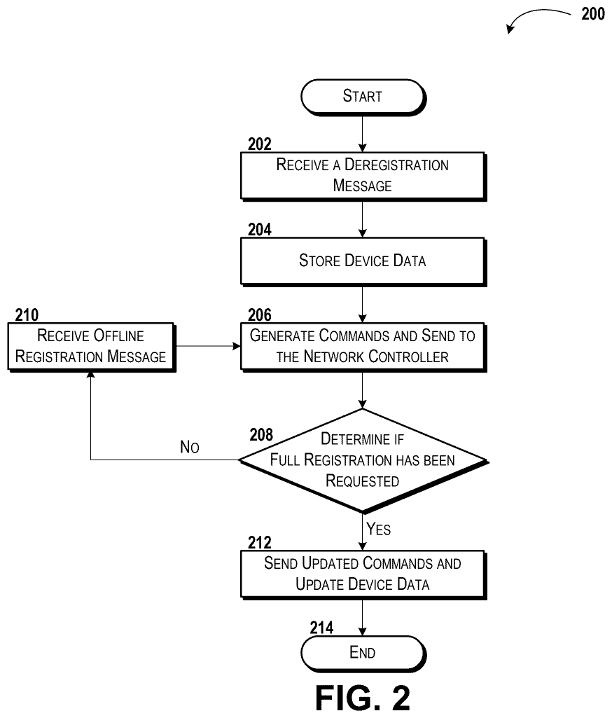

Turning now to FIG. 2, aspects of a method 200 for providing anti-fraud protection in a 5G network using offline registration will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 130, to perform one or more operations and/or causing the processor to direct other components of the computing system or device to perform one or more of the operations.

For purposes of illustrating and describing the concepts of the present disclosure, the method 200 is described herein as being performed by the server computer 130 via execution of one or more software modules such as, for example, the registration management service 128. It should be understood that additional and/or alternative devices and/or network nodes can provide the functionality described herein via execution of one or more modules, applications, and/or other software including, but not limited to, the registration management service 128. Thus, the illustrated embodiments are illustrative, and should not be viewed as being limiting in any way.

The method 200 begins at operation 202. At operation 202, the server computer 130 can receive a deregistration message 122 from a user device 102. It can be appreciated that the server computer 130 may receive the deregistration message 122 via various entities on the network 104, the 5G network, the 5G network core 126, and the like such as, for example, a gNodeB 124 or other device that communicates with the user device 102 and a transport layer of the 5G network. In any event, the deregistration message 122 can be provided to the server computer 130, and as explained herein, the deregistration message 122 can include, for example, location data that identifies a geographic location of the user device 102 when deregistering or disconnecting from the 5G network and/or other connection; one or more connection parameters associated with the connection between the user device 102 and the 5G network at the time the user device 102 deregistered and/or disconnected from the connect (e.g., an antenna the user device 102 connected to, a radio unit that served the user device 102, or the like; a signal strength of the connection; a bandwidth of the connection; a quality of service (“QoS”) for the connection and/or the user device 102; combinations thereof; or the like), and other information such as battery level and/or other operating characteristics of the user device 102. Thus, the server computer 130 can determine that the user device 102 is disconnecting from the 5G network and various operating characteristics and/or location of the user device 102. It should be understood that this example embodiment is illustrative, and therefore should not be construed as being limiting in any way.

From operation 202, the method 200 can proceed to operation 204. At operation 204, the server computer 130 can store device data 132. It can be appreciated that the various information received with the deregistration message 122 in operation 202 can be collected by the server computer 130 and stored as the device data 132 at the server computer 130 or elsewhere (e.g., a remote data storage resource or the like). According to various embodiments of the concepts and technologies disclosed herein, the device data 132 can include an operating state of the user device 102 (e.g., registered, offline, offline registration state, or the like). According to various embodiments of the concepts and technologies disclosed herein, the “offline registration state” can include a state in which the user device 102 is not fully registered and/or provisioned by the 5G network (or other network), but continues to communicate with the 5G network (or other network) for tracking, anti-fraud, and/or other purposes as illustrated and described herein. It should be understood that this example embodiment is illustrative, and therefore should not be construed as being limiting in any way.

The device data 132 also can be stored with one or more identifier for the user device 102 and/or a user thereof. Thus, the server computer 130 can key entries in the device data 132 based on device or user identifiers. This can allow the server computer 130 to lookup records for devices when a particular device is detected connecting to the 5G network. For example, if a device (such as the malicious device 142 attempting to clone the identity of the user device 102) attempts to register with the 5G network, the server computer 130 can check the device data 132 based on the identity of the user device 102. If the server computer 130 determines that the device data 132 indicates that the user device 102 is in an offline registration state, the server computer 130 can deny the subsequent registration of the malicious device 142 in some embodiments. It should be understood that this example embodiment is illustrative, and therefore should not be construed as being limiting in any way.

From operation 204, the method 200 can proceed to operation 206. At operation 206, the server computer 130 can generate commands 134 and send the commands 134 to one or more entities such as, for example, the network controller 136. As explained herein, the commands 134 can inform various entities on the network 104 and/or 5G network that the user device 102 has initiated an offline registration state, thereby enabling various entities on the network 104 and/or 5G network to prevent other devices from registering as the user device 102 (e.g., the malicious device 142 or the like). As such, it can be appreciated that the commands 134 generated by the server computer 130 in operation 206 can be configured to cause various entities to block registration of the user device 102, to modify treatment of network messages such as text messages or the like (e.g., for multi-factor authentication purposes or the like), to limit access to some services by the user device 102 (or device presenting itself as the user device 102 such as a malicious device 142 attempting to register with a spoof SIM 144), combinations thereof, or the like.

From operation 206, the method 200 can proceed to operation 208. At operation 208, the server computer 130 can determine if full registration (of the user device 102) has been requested. In some embodiments, the server computer 130 can perform operation 208 by determining if full registration of the user device 102 has been requested (e.g., if the gNodeB 124 or other device on the network 104 and/or 5G network) has received a registration message 140 from the user device 102. It can be appreciated that in some embodiments, the offline registration application 110 of the user device 102 may send a full registration request before and/or in conjunction with the registration message 140 being sent, thereby advising the server computer 130 that full registration of the user device 102 should be allowed. It should be understood that this example embodiment is illustrative, and therefore should not be construed as being limiting in any way.

If the server computer 130 determines, in operation 208, that full registration of the user device 102 has not been requested, the method 200 can proceed to operation 210. At operation 210, the server computer 130 can receive an offline registration message 138. The offline registration message 138 can advise the server computer 130 that the user device 102 is still offline, powered off, and/or otherwise has not requested full registration. It can be appreciated that the offline registration message 138 received in operation 208 can be received via the gNodeB 124, the 5G network core 126, a transport layer of the 5G network, other network connections, combinations thereof, or the like. It also can be apricated that the offline registration message 138 can be received at various intervals as illustrated and described herein. After receiving the offline registration message 138 in operation 210, the method 200 can return to operation 206, and updated commands 134 (if needed) can be generated and sent by the server computer 130 to various network entities such as the network controller 136. Thus, it can be appreciated that operations 206-210 may be iterated until the server computer 130 determines, in any iteration of operation 208, that the full registration of the user device 102 has been requested.

Although not illustrated in FIG. 2, it can be appreciated from the above description that in some embodiments, the server computer 130 can require a full registration request message from the user device 102 as part of the offline registration message 138 and/or otherwise provided by the auxiliary communication interface 118 of the user device 102 to verify that the user device 102 sent the full registration request. Without such a request, full registration of the user device 102 can be denied by the server computer 130 in some embodiments. It should be understood that this example embodiment is illustrative, and therefore should not be construed as being limiting in any way.

If the server computer 130 determines, in any iteration of operation 208, that full registration of the user device 102 has been requested (and verified in some embodiments if required by receiving a full registration request message form the user device 102), the method 200 can proceed to operation 212. At operation 212, the server computer 130 can send one or more updated versions of the commands 134 to one or more network entities (e.g., the network controller 136) and can update the device data 132. The updated versions of the commands 134 can indicate, to the recipient, that the user device 102 has exited or terminated the offline registration state. The device data 132 can be updated to indicate that the state of the user device 102 is no longer to be shown as being in an offline registration state, and instead will be shown as offline, registered, or the like. Thus, if the device data 132 is searched by the registration management service 128 or other entity after operation 212, the user device 102 will not be indicated as being in the offline registration state (and some anti-fraud services may not be performed, some services may not be denied, and the like). Because the device data 132 can be updated for additional and/or alternative reasons, it should be understood that these example embodiments are illustrative, and therefore should not be construed as being limiting in any way.

From operation 212, the method 200 can proceed to operation 214. The method 200 can end at operation 214.

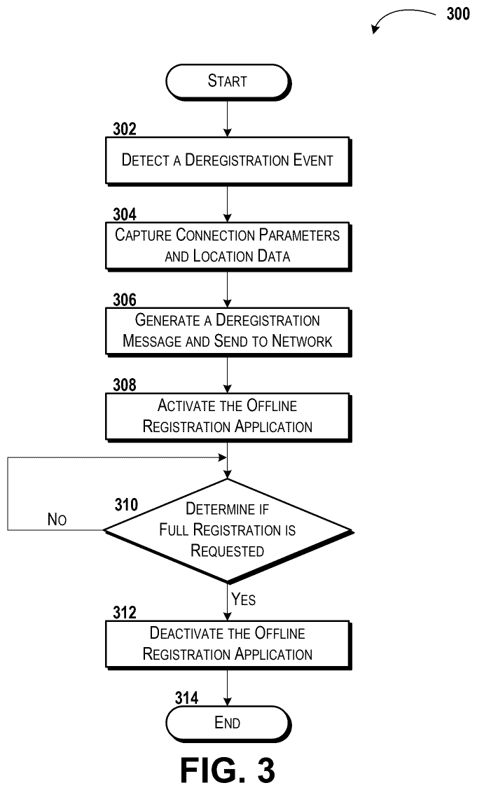

Turning now to FIG. 3, aspects of a method 300 for providing anti-fraud protection in a 5G network using offline registration will be described in detail, according to an illustrative embodiment. For purposes of illustrating and describing the concepts of the present disclosure, the method 300 is described herein as being performed by the user device 102 via execution of one or more software modules such as, for example, the registration management application 108 and/or the offline registration application 110. It should be understood that additional and/or alternative devices and/or network nodes can provide the functionality described herein via execution of one or more modules, applications, and/or other software including, but not limited to, the registration management application 108 and/or the offline registration application 110. Thus, the illustrated embodiments are illustrative, and should not be viewed as being limiting in any way.

The method 300 begins at operation 302. At operation 302, the user device 102 can detect a deregistration event. According to various embodiments of the concepts and technologies disclosed herein, the user device 102 can detect the deregistration event by detecting, for example, activation of an airplane mode at the user device 102, powering off of the user device 102, loss of a signal (e.g., a wireless communication signal between the user device 102 and a device on the 5G network) by the user device 102 and/or the 5G network, combinations thereof, or the like. In some other embodiments of the concepts and technologies disclosed herein, the user device 102 can be configured to deregister from the network 104 and/or 5G network in response to an explicit command detected at the user device 102 (e.g., via a user selection in options, an application, or the like).

In some embodiments of the concepts and technologies disclosed herein, the server computer 130 or the user device 102 may determine that signals for a connection between the user device 102 and the network 104 and/or 5G network are weakening and/or about to be lost. The server computer 130 can be configured to send a command to the user device 102 to activate the offline registration application 110, and the user device 102 may send the deregistration message 122 in response to that command. It should be understood that this example embodiment is illustrative, and therefore should not be construed as being limiting in any way. Because the deregistration event may be detected in additional and/or alternative manners, it should be understood that these example embodiments are illustrative, and therefore should not be construed as being limiting in any way.

From operation 302, the method 300 can proceed to operation 304. At operation 304, the user device 102 can capture connection parameters and location data for the user device 102. According to various embodiments of the concepts and technologies disclosed herein, the location data can identify and/or represent a geographic location of the user device 102 at a current time and/or at a time that the user device 102 is deregistering from the network 104 and/or the 5G network. The connection parameters can include, for example, various data points relating to the connection between the user device 102 and the network 104 and/or the 5G network. Thus, the connection parameters can identify, for example, an antenna via which the user device 102 is communicating, a radio unit via which the user device 102 is communicating, other hardware with which the user device 102 is connected; a signal strength, bandwidth, and/or quality of service for the connection between the user device 102 and the network 104 and/or 5G network; other information relating to the user device 102 such as a battery level of a primary power source and/or the auxiliary power source 116; other operating characteristics of the user device 102 such as user verification and/or authentication information; combinations thereof; or the like. These and/or other information can be captured by the user device 102. It should be understood that this example embodiment is illustrative, and therefore should not be construed as being limiting in any way.

From operation 304, the method 300 can proceed to operation 306. At operation 306, the user device 102 can generate a deregistration message 122 and send the deregistration message 122 to the network 104. The user device 102 can include, in or with the deregistration message 122, the location data and/or connection parameters captured in operation 304. The user device 102 can send the deregistration message 122 to the gNodeB 124 and/or other devices on the network 104 and/or 5G network. In some embodiments, the deregistration message 122 can be sent by the user device 102 to the gNodeB 124, and the gNodeB 124 can route the deregistration message 122 to the registration management service 128 via the 5G network core 126, a transport layer of the 5G network, and/or other devices or links. It should be understood that this example embodiment is illustrative, and therefore should not be construed as being limiting in any way.

From operation 306, the method 300 can proceed to operation 308. At operation 308, the user device 102 can activate and/or invoke the offline registration application 110. In some embodiments of the concepts and technologies disclosed herein, the user device 102 can send the deregistration message 122 in operation 306, and the network controller 136, the registration management service 128, and/or other entities can be configured to trigger activation of the offline registration application 110 (e.g., by delivering a command to the user device 102 via the gNodeB 124 and/or other entities, where the command activates or invokes the offline registration application 110). In some other embodiments, the registration management application 108 and/or operating system 106 at the user device 102 can be configured to activate the offline registration application 110 when the user device 102 is about to be powered off, when the user device 102 is about to lose its signal, when an airplane mode is activated at the user device 102, and/or at other times. Because the offline registration application 110 can be activated at additional and/or alternative times, it should be understood that these example embodiments are illustrative, and therefore should not be construed as being limiting in any way.

From operation 308, the method 300 can proceed to operation 310. At operation 310, the user device 102 can determine if full registration (of the user device 102) is being requested. In some embodiments, the user device 102 can perform operation 310 by determining if full registration of the user device 102 has been requested at the user device 102. For example, the user device 102 can determine, in operation 310, if the user device 102 has been powered on again, if the airplane mode has been deactivated and/or terminated, if an application option has been selected to change the state of the user device 102 from offline registration state to an “online,” “registered,” “provisioned,” “active,” “normal,” and/or other similar operating state, or other action has been taken that represents a request for full registration of the user device 102. It also can be appreciated that in some embodiments of operation 310, operation 310 can include the user device 102 sending a full registration request to the gNodeB 124 and/or other entities as part of an offline registration message 138 before considering that full registration has been requested. It should be understood that this example embodiment is illustrative, and therefore should not be construed as being limiting in any way. Also, because full registration of the user device 102 can be requested in additional and/or alternative manners, it should be understood that these example embodiments are illustrative, and therefore should not be construed as being limiting in any way.

If the user device 102 determines, in operation 310 that full registration of the user device 102 is not being requested, the method 300 can return to operation 310. Thus, it can be appreciated that performance of the method 300 can pause at operation 310 until the user device 102 determines, in any iteration of operation 310, that full registration of the user device is being requested. If the user device 102 determines, in any iteration of operation 310, that full registration of the user device 102 is being requested, the method 300 can proceed to operation 312.

At operation 312, the user device 102 can deactivate the offline registration application 110. In operation 312, the user device 102 can deactivate the offline registration application 110, which can cause the user device 102 to stop sending offline registration messages 138. The user device 102 also can hand control of registration of the user device 102 back to the registration management application 108 and/or the operating system 106. It should be understood that this example embodiment is illustrative, and therefore should not be construed as being limiting in any way.

From operation 312, the method 300 can proceed to operation 314. The method 300 can end at operation 314.

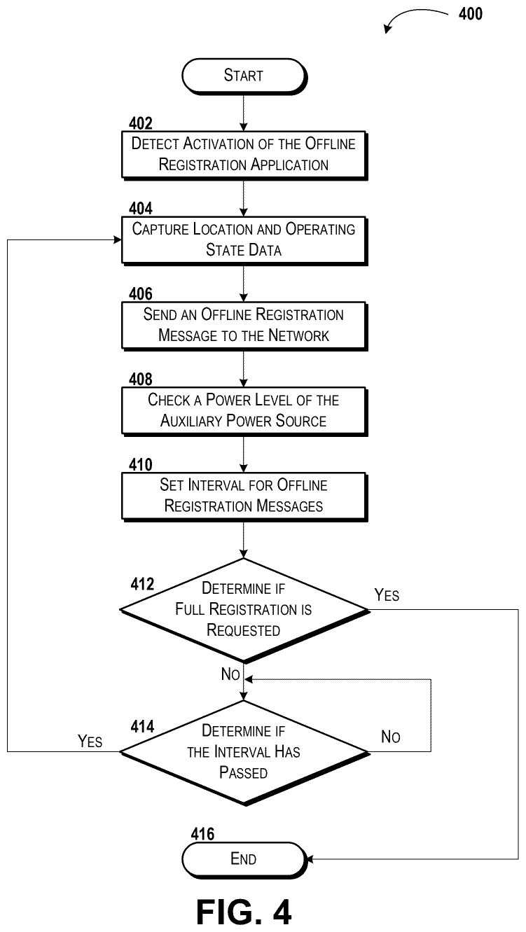

Turning now to FIG. 4, aspects of a method 400 for providing anti-fraud protection in a 5G network using offline registration will be described in detail, according to an illustrative embodiment. For purposes of illustrating and describing the concepts of the present disclosure, the method 400 is described herein as being performed by the user device 102 via execution of one or more software modules such as, for example, the registration management application 108 and/or the offline registration application 110. It should be understood that additional and/or alternative devices and/or network nodes can provide the functionality described herein via execution of one or more modules, applications, and/or other software including, but not limited to, the registration management application 108 and/or the offline registration application 110. Thus, the illustrated embodiments are illustrative, and should not be viewed as being limiting in any way.

The method 400 begins at operation 402. At operation 402, the user device 102 can detect activation of the offline registration application 110. In some embodiments of operation 402, the user device 102 can detect activation of the offline registration application 110 by detecting that a command or instruction has been received to enter an offline registration state, by detecting that the offline registration application 110 has been invoked and/or activated by the registration management application 108, and/or the like.

From operation 402, the method 400 can proceed to operation 404. At operation 404, the user device 102 can capture location and operating state data. In some embodiments of operation 404, the user device 102 can capture operating state data for the user device 102. The operating state data can include, for example, a state of the user device 102 (e.g., powered on, powered off, moving, stationary, or the like); a state of a connection between the user device 102 and the gNodeB 124 that is provided by a primary communication interface of the user device 102 such as a cellular transceiver, by an auxiliary communication interface 118, or the like); a user authentication state (e.g., user has been authenticated, user is unknown, or the like, which can include the user device 102 determining if a user has authenticated with the user device 102 by a fingerprint, face, or other biometric information); other information; and the like. The location data captured by the user device 102 can include location data that defines a geographic location of the user device 102 at the time that activation of the offline registration application 110 is detected. Thus, it can be appreciated that the location data captured in operation 404 can be captured by the auxiliary location device 114. It should be understood that this example embodiment is illustrative, and therefore should not be construed as being limiting in any way.

From operation 404, the method 400 can proceed to operation 406. At operation 406, the user device 102 can send an offline registration message 138 to the network 104. According to various embodiments of the concepts and technologies disclosed herein, the user device 102 can activate the auxiliary communication interface 118 to transmit the offline registration message 138 to the network 104 and/or the 5G network (e.g., by transmitting the offline registration message 138 to the gNodeB 124). The auxiliary communication interface 118 can include a lightweight and/or low-power transceiver that can send small bursts of data (e.g., the offline registration messages 138) to the gNodeB 124 using power from the auxiliary power source 116. It should be understood that this example embodiment is illustrative, and therefore should not be construed as being limiting in any way.

From operation 406, the method 400 can proceed to operation 408. At operation 408, the user device 102 can check a power level of the auxiliary power source 116. The power level can be gauged in percentages of total capacity (e.g., fifty percent available, one hundred percent available, or the like), in terms of actual power level (e.g., by measuring voltage of the auxiliary power source 116), and/or in other manners. Because the power level of the auxiliary power source 116 can be determined in other manners, and because the power level can be defined according to other measures, it should be understood that these example embodiments are illustrative, and therefore should not be construed as being limiting in any way.

From operation 408, the method 400 can proceed to operation 410. At operation 410, the user device 102 can set an interval for sending the offline registration messages 138. As explained herein, the user device 102 can determine the interval for sending the offline registration messages 138 (and associated location data and operating state data) based on the power level of the auxiliary power source 116. As the power level of the auxiliary power source 116 drops, the user device 102 can decrease the frequency of the transmission of offline registration messages 138 (to avoid running the power out of the auxiliary power source 116 while the user device 102 is in the offline registration state). It should be understood that this example embodiment is illustrative, and therefore should not be construed as being limiting in any way.

Thus, in some embodiments of the concepts and technologies disclosed herein, the user device 102 can be configured (e.g., via execution of the offline registration application 110) to manage the power consumption from the auxiliary power source 116 to attempt to lengthen the amount of time that the offline registration messages 138 can be sent by the user device 102. The user device 102 can set the interval for offline registration messages 138 based on the power level of the auxiliary power source 116, and this interval can be periodically updated by the user device 102 based on the periodically updated power level of the auxiliary power source 116. It should be understood that this example embodiment is illustrative, and therefore should not be construed as being limiting in any way.

According to various embodiments, as noted herein, the user device 102 can access and/or can store data that indicates an amount of power consumed by sending one offline registration message 138. Thus, the user device 102 can determine, based on this information and a current measured power level of the auxiliary power source 116, an amount of time the auxiliary power source 116 can last. The user device 102 can adjust the interval to lengthen the duration of the life of the auxiliary power source 116 in various embodiments. Because the interval can be determined in additional and/or alternative manners, it should be understood that this example embodiment is illustrative, and therefore should not be construed as being limiting in any way.

From operation 410, the method 400 can proceed to operation 412. At operation 412, the user device 102 can determine if full registration (of the user device 102) is being requested. The user device 102 determines if full registration of the user device 102 has been requested by detecting, in operation 412, that the user device 102 has been powered on again, that an airplane mode has been deactivated and/or terminated, that an application option has been selected to change the state of the user device 102 from offline registration state to an online registration state or the like, and/or by detecting some other action that represents a request for full registration of the user device 102.

It also can be appreciated that in some embodiments of operation 412, operation 412 can include the user device 102 sending a full registration request to the gNodeB 124 and/or other entities as part of an offline registration message 138 before considering that full registration has been requested. It should be understood that this example embodiment is illustrative, and therefore should not be construed as being limiting in any way. Also, because full registration of the user device 102 can be requested in additional and/or alternative manners, it should be understood that these example embodiments are illustrative, and therefore should not be construed as being limiting in any way.

If the user device 102 determines, in operation 412 that full registration of the user device 102 has not being requested, the method 400 can proceed to operation 414. At operation 414, the user device 102 can determine if the interval (set in operation 410) has passed. If the user device 102 determines, in operation 414 that the interval set in operation 410 has not passed, the method 400 can return to operation 414. Thus, it can be appreciated that performance of the method 400 can pause at operation 414 until the user device 102 determines that the interval defined at operation 410 has passed.

If the user device 102 determines, in operation 414 that the interval set in operation 410 has passed, the method 400 can return to operation 404, and the user device 102 can again capture location and operating state data, again send an offline registration message 138 to the network 104, again check the power level of the auxiliary power source 116, again set (e.g., reset, modify, or leave unchanged) the interval for the offline registration messages 138, again determine if full registration is being requested, and follow the flow from the additional iteration of operation 412 based on the outcome at operation 412. Thus, it can be appreciated that performance of operations 404-414 can be iterated until the user device 102 determines, in any iteration of operation 412, that full registration of the user device 102 is being requested.

If the user device 102 determines, in any iteration of operation 412, that full registration of the user device 102 is being requested, the method 400 can proceed to operation 416. The method 400 can end at operation 416.

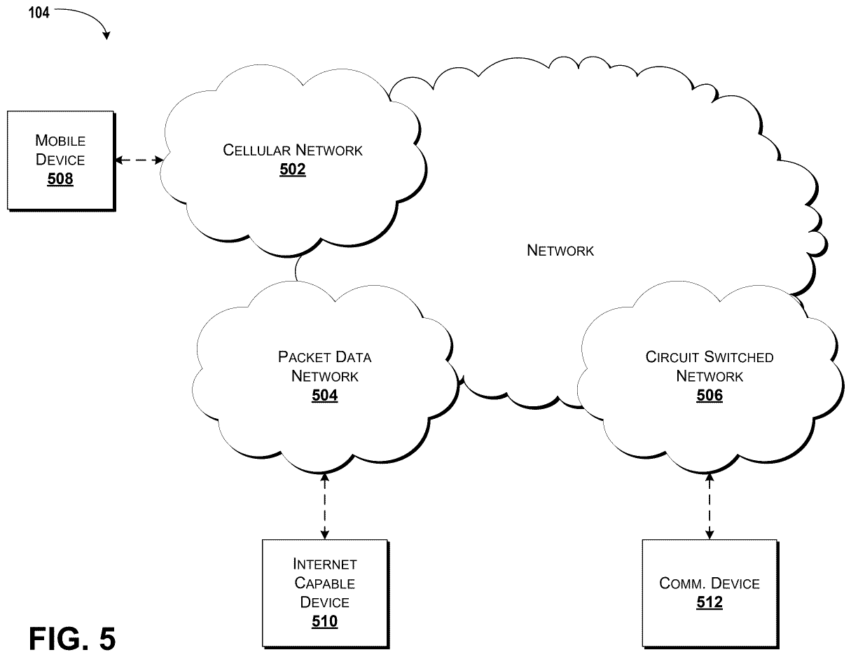

Turning now to FIG. 5, additional details of the network 104 are illustrated, according to an illustrative embodiment. The network 104 includes a cellular network 502, a packet data network 504, for example, the Internet, and a circuit switched network 506, for example, a publicly switched telephone network (“PSTN”). The cellular network 502 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, 6G mobile communication standards, other mobile communications standards, and evolved and future mobile communications standards. Moreover, the cellular network 502 may facilitate communications over various channel access methods (which may or may not be used by the aforementioned standards) including, but not limited to, TDMA, FDMA, W-CDMA, OFDM, SDMA, and the like. In addition, the cellular network 502 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the network 104 is used to refer broadly to any combination of the networks 502, 504, 506. It should be appreciated that substantially all of the functionality described with reference to the network 104 can be performed by the cellular network 502, the packet data network 504, and/or the circuit switched network 506, alone or in combination with other networks, network elements, and the like.

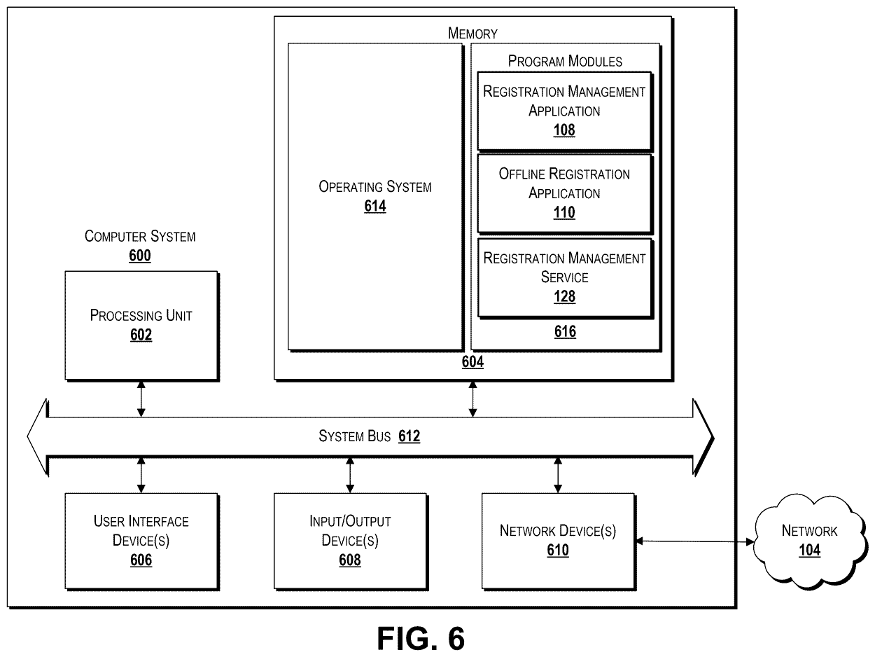

FIG. 6 is a block diagram illustrating a computer system 600 configured to provide the functionality described herein for providing anti-fraud protection in a 5G network using offline registration, in accordance with various embodiments of the concepts and technologies disclosed herein. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 include the registration management application 108, the offline registration application 110, and/or the registration management service 128. These and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, and 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the deregistration message 122, the device data 132, the commands 134, offline registration messages 138, the registration message 140, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the network 104. Examples of the network devices 610 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

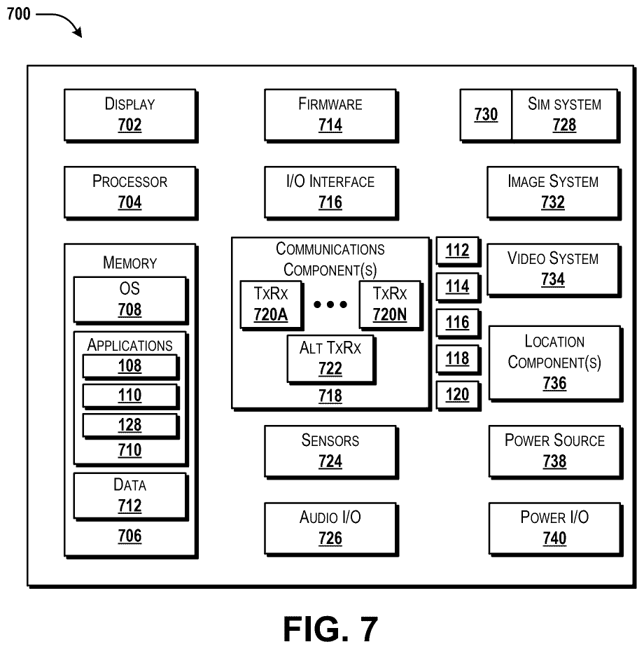

Turning now to FIG. 7, an illustrative mobile device 700 and components thereof will be described. In some embodiments, the user device 102 described above with reference to FIGS. 1-4 can be configured as and/or can have an architecture similar or identical to the mobile device 700 described herein in FIG. 7. It should be understood, however, that the user device 102 may or may not include the functionality described herein with reference to FIG. 7. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. As shown in FIG. 7, the mobile device 700 also can include an auxiliary processor 112, which can be configured to process data and/or execute computer-executable instructions stored in the memory 706 and/or the auxiliary storage 120 illustrated and described herein. It should be understood that this example embodiment is illustrative, and therefore should not be construed as being limiting in any way. The computer-executable instructions executed by the processor 704 can include, for example, an operating system 708, one or more applications 710 such as the registration management application 108, the offline registration application 110, and/or the registration management service 128, other computer-executable instructions stored in a memory 706, or the like. In some embodiments, the applications 710 also can include a UI application (not illustrated in FIG. 7).

The UI application can interface with the operating system 708, such as the operating system 106 shown in FIG. 1, to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. The data 712 can include, for example, the registration management application 108, the offline registration application 110, and/or the registration management service 128, and/or other applications or program modules. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an N^{th} transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like. As shown in FIG. 7, the mobile device 700 also can include an auxiliary communication interface 118, which can include a transceiver, receiver, transmitter and/or other device, including any of the example devices listed above for the communications component 718. It should be understood that this example embodiment is illustrative, and therefore should not be construed as being limiting in any way.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700. As shown in FIG. 7, the mobile device 700 also can include an auxiliary location device 114, which can include a GPS device and/or other location determination device as illustrated and described herein. It should be understood that this example embodiment is illustrative, and therefore should not be construed as being limiting in any way.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. As shown in FIG. 7, the mobile device 700 also can include the auxiliary power source 116 as illustrated and described herein. The auxiliary power source 116 also can include one or more batteries, power supplies, power cells, and/or other power subsystems including AC and/or DC power devices. As noted herein, the auxiliary power source 116 can also include an inductively charged device that charges the mobile device 700 if and/or when the mobile device 700 is moved. It should be understood that this example embodiment is illustrative, and therefore should not be construed as being limiting in any way. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

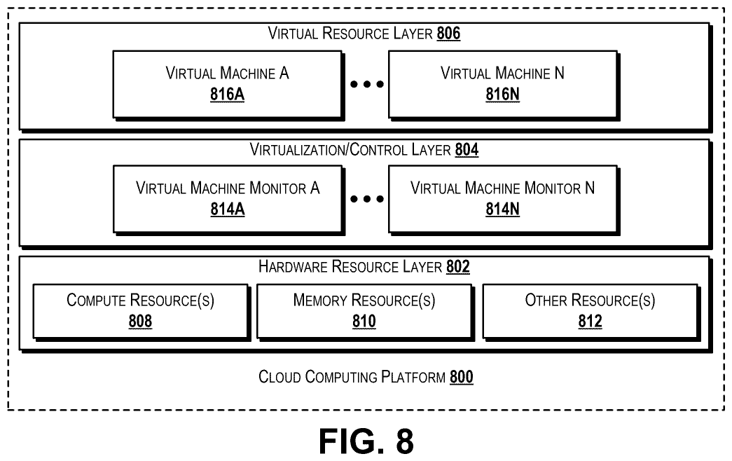

FIG. 8 illustrates an illustrative architecture for a cloud computing platform 800 that can be capable of executing the software components described herein for providing anti-fraud protection in a 5G network using offline registration and/or for interacting with the registration management application 108, the offline registration application 110, and/or the registration management service 128. Thus, it can be appreciated that in some embodiments of the concepts and technologies disclosed herein, the cloud computing platform 800 illustrated in FIG. 8 can be used to provide the functionality described herein with respect to the server computer 130, the network controller 136, and/or the malicious device 142.

The cloud computing platform 800 thus may be utilized to execute any aspects of the software components presented herein. Thus, according to various embodiments of the concepts and technologies disclosed herein, the registration management application 108, the offline registration application 110, and/or the registration management service 128, can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the registration management application 108, the offline registration application 110, and/or the registration management service 128 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the registration management application 108, the offline registration application 110, the registration management service 128, and/or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, the deregistration message 122, the device data 132, the commands 134, offline registration messages 138, the registration message 140, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing anti-fraud protection in a 5G network using offline registration have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
receiving a deregistration message generated by a user device in communication with a gNodeB of a fifth generation (“5G”) network, wherein the deregistration message is received with location data that indicates a geographic location of the user device when a deregistration event occurs, and connection parameters that define a connection between the user device and the gNodeB;
storing device data that identifies the user device and defines a state of the user device as being an offline registration state;
generating a command that indicates that the user device is in the offline registration state;
sending, to a network controller operating on the 5G network, the command, wherein the network controller prevents registration of devices that appear to be the user device until an updated command is received;
receiving, from the user device, an offline registration message that is sent by the user device using an auxiliary communication interface of the user device, wherein the offline registration message includes further location data that is captured by an auxiliary location device of the user device and operating state data for the user device; and
in response to detecting a request for full registration of the user device, updating the device data to indicate that the state of the user device is registered, and sending the updated command to the network controller to stop preventing registration of the devices that appear to be the user device.

2. The system of claim 1, wherein the request for the full registration of the user device comprises a validation message generated by the user device and sent via the auxiliary communication interface.

3. The system of claim 1, wherein the command causes the network controller to prevent delivery of text messages to the devices that appear to be the user device until the updated command is received.

4. The system of claim 1, wherein the deregistration event comprises powering off of the user device.

5. The system of claim 1, wherein a further offline registration message is received after a first time interval passes after receiving the offline registration message, wherein the first time interval is set by the user device based on a power level of an auxiliary power source of the user device after sending the offline registration message, wherein another offline registration message is received after a second time interval passes after receiving the further offline registration message, and wherein the second time interval is set by the user device based on a further power level of the auxiliary power source of the user device after sending the further offline registration message.

6. The system of claim 1, wherein the computer-executable instructions, when executed by the processor, cause the processor to perform operations further comprising:
instructing the user device to activate an offline registration application in response to determining that the user device is about to lose the connection between the user device and the gNodeB; and
comparing, after the full registration is requested, updated location data that indicates an updated geographic location of the user device and updated connection parameters to determine if the user device is requesting the full registration or if a malicious device is attempting to register as the user device.

7. The system of claim 1, wherein the deregistration message is received at an access and mobility management function of the 5G network, wherein the network controller comprises a unified data registry and a unified data management entity of the 5G network.

8. A method comprising:
receiving, at a computer comprising a processor, a deregistration message generated by a user device in communication with a gNodeB of a fifth generation (“5G”) network, wherein the deregistration message is received with location data that indicates a geographic location of the user device when a deregistration event occurs, and connection parameters that define a connection between the user device and the gNodeB;
storing, by the processor, device data that identifies the user device and defines a state of the user device as being an offline registration state;
generating, by the processor, a command that indicates that the user device is in the offline registration state;
sending, by the processor and to a network controller operating on the 5G network, the command, wherein the network controller prevents registration of devices that appear to be the user device until an updated command is received;
receiving, by the processor and from the user device, an offline registration message that is sent by the user device using an auxiliary communication interface of the user device, wherein the offline registration message includes further location data that is captured by an auxiliary location device of the user device and operating state data for the user device; and
in response to detecting a request for full registration of the user device, updating, by the processor, the device data to indicate that the state of the user device is registered, and sending the updated command to the network controller to stop preventing registration of the devices that appear to be the user device.

9. The method of claim 8, wherein the request for the full registration of the user device comprises a validation message generated by the user device and sent via the auxiliary communication interface.

10. The method of claim 8, wherein the command causes the network controller to prevent delivery of text messages to the devices that appear to be the user device until the updated command is received.

11. The method of claim 8, wherein the deregistration event comprises powering off of the user device.

12. The method of claim 8, wherein a further offline registration message is received after a first time interval passes after receiving the offline registration message, wherein the first time interval is set by the user device based on a power level of an auxiliary power source of the user device after sending the offline registration message, wherein another offline registration message is received after a second time interval passes after receiving the further offline registration message, and wherein the second time interval is set by the user device based on a further power level of the auxiliary power source of the user device after sending the further offline registration message.

13. The method of claim 8, further comprising:
instructing the user device to activate an offline registration application in response to determining that the user device is about to lose the connection between the user device and the gNodeB; and
comparing, after the full registration is requested, updated location data that indicates an updated geographic location of the user device and updated connection parameters to determine if the user device is requesting the full registration or if a malicious device is attempting to register as the user device.

14. A computer storage medium having computer-executable instructions stored thereon that, when executed by a processor, cause the processor to perform operations comprising:
receiving a deregistration message generated by a user device in communication with a gNodeB of a fifth generation (“5G”) network, wherein the deregistration message is received with location data that indicates a geographic location of the user device when a deregistration event occurs, and connection parameters that define a connection between the user device and the gNodeB;
storing device data that identifies the user device and defines a state of the user device as being an offline registration state;
generating a command that indicates that the user device is in the offline registration state;
sending, to a network controller operating on the 5G network, the command, wherein the network controller prevents registration of devices that appear to be the user device until an updated command is received;
receiving, from the user device, an offline registration message that is sent by the user device using an auxiliary communication interface of the user device, wherein the offline registration message includes further location data that is captured by an auxiliary location device of the user device and operating state data for the user device; and
in response to detecting a request for full registration of the user device, updating the device data to indicate that the state of the user device is registered, and sending the updated command to the network controller to stop preventing registration of the devices that appear to be the user device.

15. The computer storage medium of claim 14, wherein the request for the full registration of the user device comprises a validation message generated by the user device and sent via the auxiliary communication interface.

16. The computer storage medium of claim 14, wherein the command causes the network controller to prevent delivery of text messages to the devices that appear to be the user device until the updated command is received.

17. The computer storage medium of claim 14, wherein the deregistration event comprises powering off of the user device.

18. The computer storage medium of claim 14, wherein a further offline registration message is received after a first time interval passes after receiving the offline registration message, wherein the first time interval is set by the user device based on a power level of an auxiliary power source of the user device after sending the offline registration message, wherein another offline registration message is received after a second time interval passes after receiving the further offline registration message, and wherein the second time interval is set by the user device based on a further power level of the auxiliary power source of the user device after sending the further offline registration message.

19. The computer storage medium of claim 14, wherein the computer-executable instructions, when executed by the processor, cause the processor to perform operations further comprising:
instructing the user device to activate an offline registration application in response to determining that the user device is about to lose the connection between the user device and the gNodeB; and
comparing, after the full registration is requested, updated location data that indicates an updated geographic location of the user device and updated connection parameters to determine if the user device is requesting the full registration or if a malicious device is attempting to register as the user device.

20. The computer storage medium of claim 14, wherein the deregistration message is received at an access and mobility management function of the 5G network, wherein the network controller comprises a unified data registry and a unified data management entity of the 5G network.
